(19) United States
(12) Patent Application Publication
(10) Pub. No.: US 2026/0365262 A1
(43) Pub. Date: Nov. 19, 2026

(54) Dynamically Adjustable Gooseneck Ball Mount

(71) Applicant: Gen-Y Creations, LLC, Nappanee, IN (US)

(72) Inventor: Carl J. Borkholder, Nappanee, IN (US)

(73) Assignee: Gen-Y Creations, LLC, Nappanee, IN (US)

(21) Appl. No.: 19/748,281

(22) Filed: Jul. 21, 2026

Related U.S. Application Data
(63) Continuation of application No. 18/438,682, filed on Feb. 12, 2024, now Pat. No. 12,741,704.

(51) Int. Cl. B62D 53/08

(52) U.S. Cl. CPC B62D 53/0814

(57) ABSTRACT

A dynamically adjustable gooseneck mount has a linear actuator that is removably affixed to a towing vehicle over the vehicle’s rear axle. A gooseneck ball is affixed to a movable portion of the actuator and can move between a forward position and a rearward position through operation of a motor. A controller detects a driving condition, and when that driving condition crosses a threshold, the actuator moves the gooseneck ball from a fore position to an aft position. When the threshold is crossed in the opposite direction, the actuator moves the gooseneck ball from the aft position to the fore position. In the fore position, the gooseneck ball is over the rear axle, and in the aft position, the gooseneck ball is located aft of the rear axle. The controller can include a bed mounted portion and a cab mounted portion that communicate wirelessly.

### CROSS REFERENCE TO RELATED APPLICATIONS

This application is a Continuation-in-Part of U.S. Application Serial No. 18/438,682, filed Feb. 12, 2024, the disclosure of which is incorporated by reference.

### BACKGROUND OF THE INVENTION

The present disclosure relates to devices that attach a trailer to a towing vehicle. 5^{th} wheel and gooseneck trailers have towing setup requirements, such as locating the tongue weight of the trailer over the towing vehicle’s axle. For short bed trucks, locating the tongue weight directly over the axle places the front of some trailers (such as recreational vehicles) close enough to the cab that turning too tightly causes the front of the trailer to contact the cab, damaging both the trailer and truck. Other devices have attempted to solve this problem by positioning the trailer connection point rearward of the axle. By positioning the trailer rearward, the problem created by turning is solved, but the rearward bias of the tongue load makes the entire towing dynamic of truck and trailer less stable. Further, the increased distance between the truck cab and nose of the trailer increases wind resistance and lowers fuel economy.

Since tight turning is only performed when parking or moving at slow speeds, the trailer connection point only needs to be biased rearward periodically. Others have attempted to solve this problem, such as the sliding 5^{th} wheel hitches in US 7,753,392 and US 9,511,804. This device only works with 5^{th} wheel and pin box connections and requires a part to be affixed to the trailer to engage with the entry slot of the 5^{th} wheel hitch plate and prevent the trailer from rotating with respect to the 5^{th} wheel. Instead, the mechanism is forced to rotate the 5^{th} wheel when the truck turns with respect to the trailer. This causes a mechanism to rotate and slide rearward through a large rack and pinion gear engagement or cam following a slot. This setup is not applicable to a gooseneck trailer, as there is no simple way to keep the trailer from rotating with respect to the connection point. Further, binding of the mechanical components can create unexpected torsional stress in the pin box or accidents from unduly restricted movement between truck and trailer. Other known issues with this setup includes wear or slop in the mechanism that causes undesirable chucking or banging between the truck and trailer. An improved device is needed.

### SUMMARY OF THE INVENTION

The present disclosure describes an assembly for attaching a trailer to a towing vehicle having an axle, a gooseneck pocket, and at least two anchor points offset from the gooseneck pocket. The assembly comprises a base frame, a linear actuator, and a controller. The base frame is configured to be removably affixed to the towing vehicle and has a stem fixed with respect to the base frame. The stem has a stem axis and the base frame has at least one fastener for being received by the vehicle anchor points. The fastener is rotatable between a locked position and an unlocked position. The linear actuator has a motor and a stationary portion affixed to the base frame. The actuator has a gooseneck ball that is moveable with respect to the base frame between a first position and a second position. The gooseneck ball has a gooseneck axis. The controller is in electrical communication with the towing vehicle and the linear actuator. When the controller detects a first driving condition of the towing vehicle, the linear actuator moves the gooseneck ball to the first position and when the controller detects a second driving condition of the towing vehicle, the linear actuator moves the gooseneck ball to the second position. The driving condition of the towing vehicle is typically the vehicle’s speed, and the first position locates the gooseneck ball over the gooseneck pocket and/or rear axle when the speed is below a predetermined value. The second position locates the gooseneck ball rearward of the gooseneck pocket and/or rear axle when the speed is above the predetermined value.

### BRIEF DESCRIPTION OF THE DRAWINGS

FIG. 1 is a side view of a trailer coupled to a towing vehicle;

FIG. 2 is a top isometric view of the towing vehicle and coupler in FIG. 1;

FIG. 3 is a front isometric view of the coupler and front portion of the trailer in FIG. 1;

FIG. 4 is a rear isometric view of the coupler;

FIG. 5 is a bottom isometric view of the coupler;

FIG. 6 is a side section view 6-6 of the coupler in FIG. 4 in the fore position;

FIG. 7 is a side section view 6-6 of the coupler in FIG. 4 in the aft position;

FIG. 8 is a top isometric view of the coupler in the aft position;

FIG. 9 is a top view of the towing vehicle and trailer in alignment and coupler in the fore position, along with the trailer at an angle and coupler in the aft position, shown in broken lines;

FIG. 10A is a graphical representation of the travel of the actuator versus the angle of the trailer using a digital sensor;

FIG. 10B is a graphical representation of the travel of the actuator versus the angle of the trailer using an angle sensor and programmable setpoints;

FIG. 11 is an isometric section view 11-11 of the fastener portion of the coupler in FIG. 4;

FIG. 12 is a block diagram of a new embodiment of the coupler showing controls and connections;

FIG. 13 is a top isometric view of the coupler in FIG. 12;

FIG. 14 is a section view 14-14 of the coupler in FIG. 13 in the fore position; and

FIG. 15 is a section view 14-14 of the coupler in FIG. 13 in the aft position.

### DESCRIPTION OF THE PREFERRED EMBODIMENT

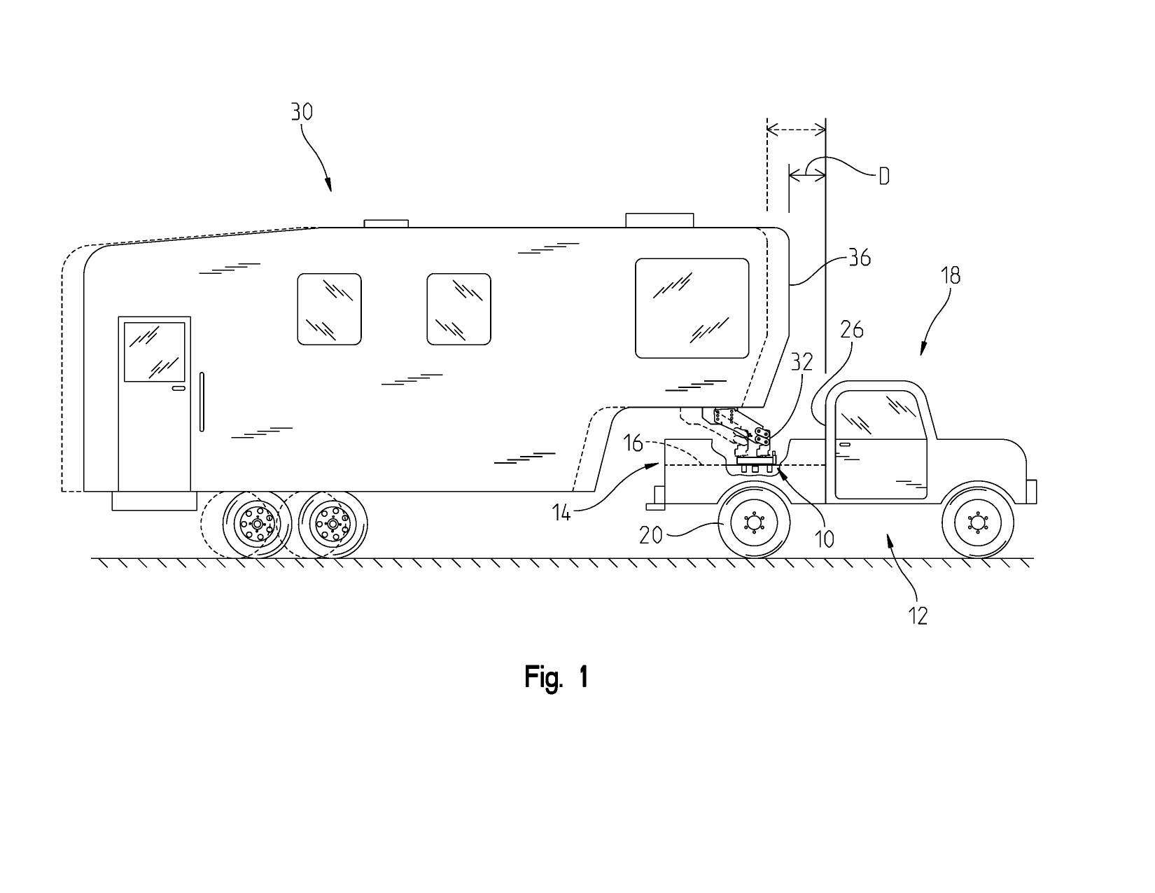

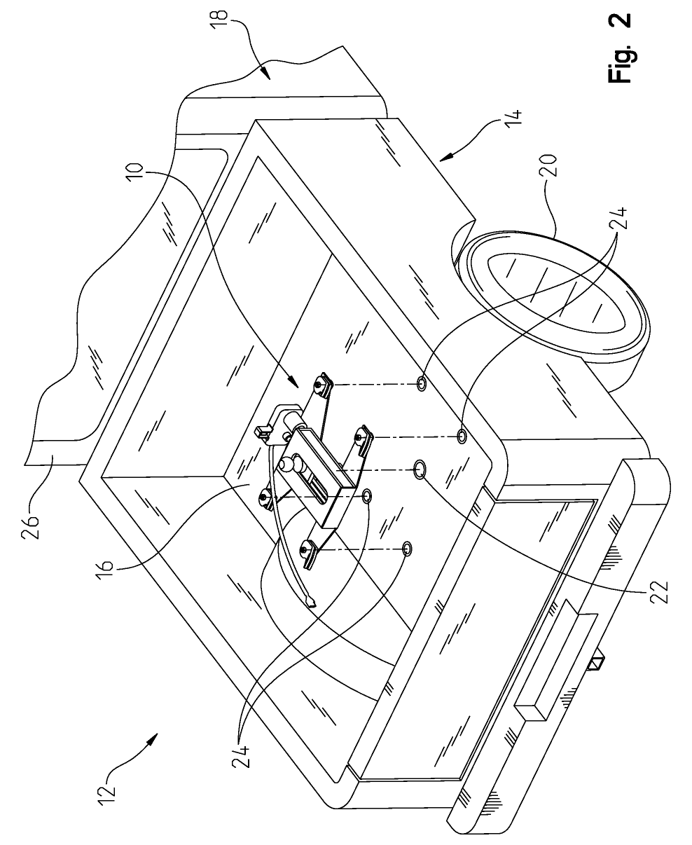

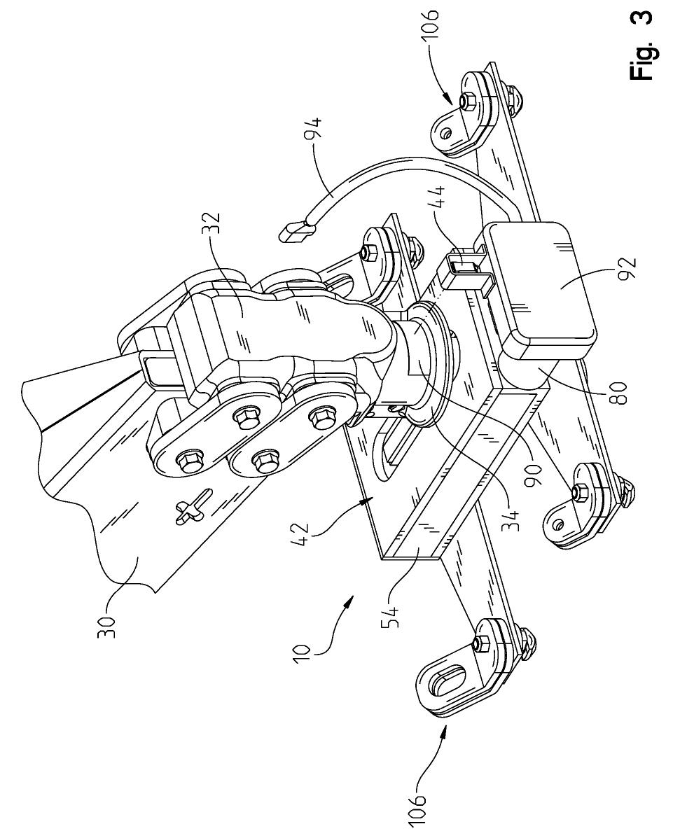

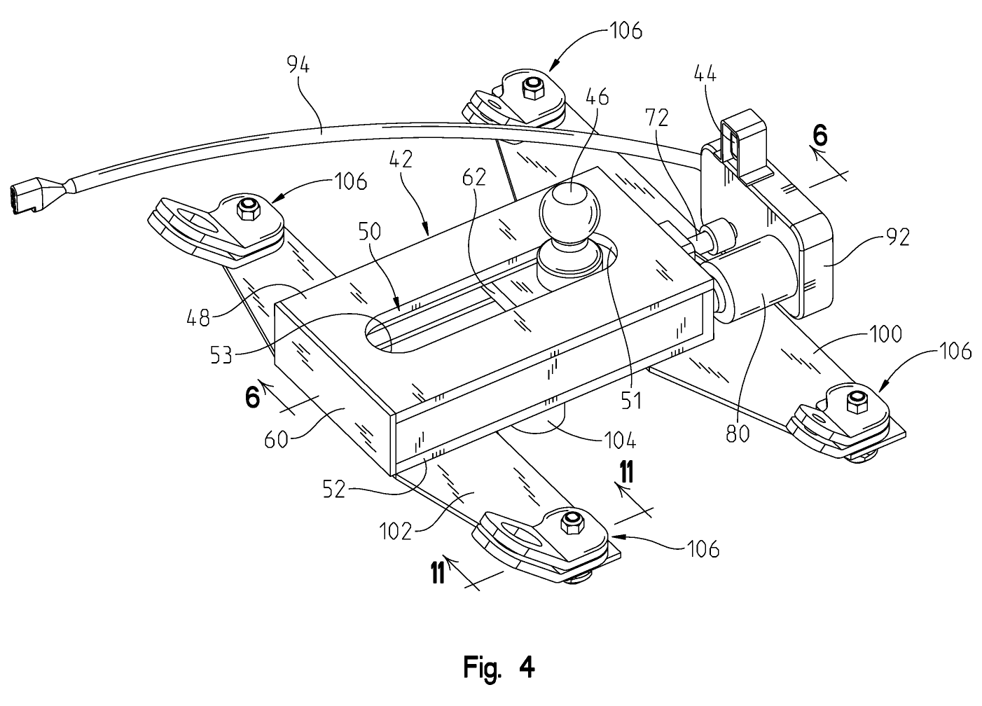

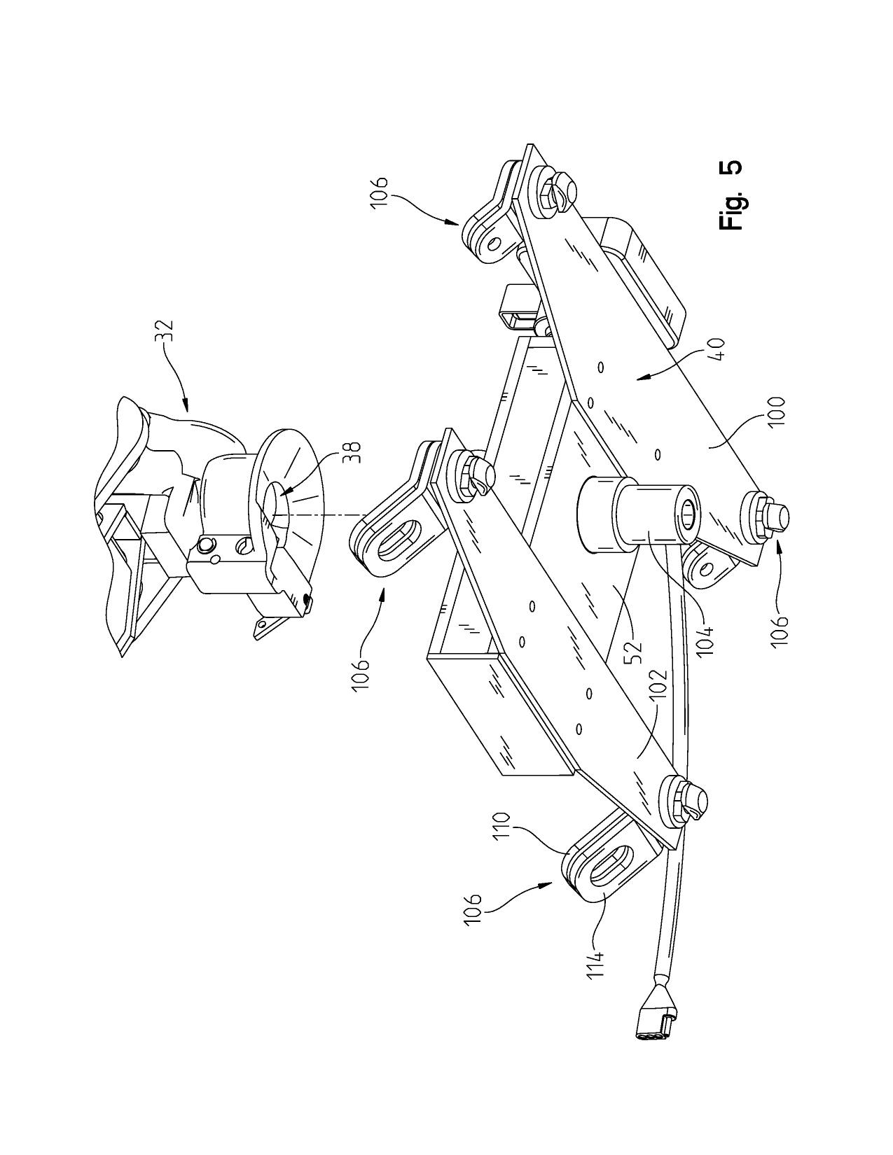

A trailer coupler 10 is shown in FIG. 1 that attaches to the bed of a towing vehicle 12. The towing vehicle 12 has a bed 14 with a floor 16 and a cab 18 that is forward of the bed 14. The bed 14 is located over an axle 20 and may consist of a flat surface, frame rails, or other type of mounting platform that allows secure attachment to the vehicle’s structure. The mounting platform or bed 14 may include a puck system that has a gooseneck pocket 22 and at least one additional anchor point 24. In the embodiment shown in FIG. 2, the towing vehicle 12 has four anchor points 24 that are spaced from the gooseneck pocket 22. The gooseneck pocket 22 is laterally (side to side) centered over the axle 20 but may be longitudinally (fore or aft) offset from the axle 20. For the purposes of this disclosure, longitudinal movement or position is in the direction of travel of the towing vehicle. The gooseneck pocket 22 and anchor points 24 are rigidly affixed to the vehicle’s frame and accessed at or through the floor 16 of the bed 14. The trailer coupler 10 is designed to mate with a trailer 30, shown in FIG. 3. It is contemplated that the towing vehicle 12 uses an alternative device or method for attaching, such as a bed rail system (not shown). Bed rail systems typically consist of two parallel rails mounted over the rear axle in a direction perpendicular to the direction of travel.

As shown, the trailer 30 has a gooseneck coupler 32 that provides a secure connection to a gooseneck ball 46. The gooseneck coupler 32 has a lead-in flange 34 that leads to a ball pocket. When the gooseneck coupler 32 is latched, the spherical portion of the gooseneck ball is trapped while still allowing rotation of the gooseneck ball 46 with respect to the gooseneck coupler 32. In other words, the gooseneck coupler 32 does not impart rotational movement to the gooseneck ball 46. The trailer 30 has a front surface 36 that faces the rear surface 26 of the cab 18, shown in FIG. 1. The distance D between the front surface 36 of the trailer 30 and rear surface 26 of the cab 18 varies based on the individual towing vehicle 12 and trailer 30.

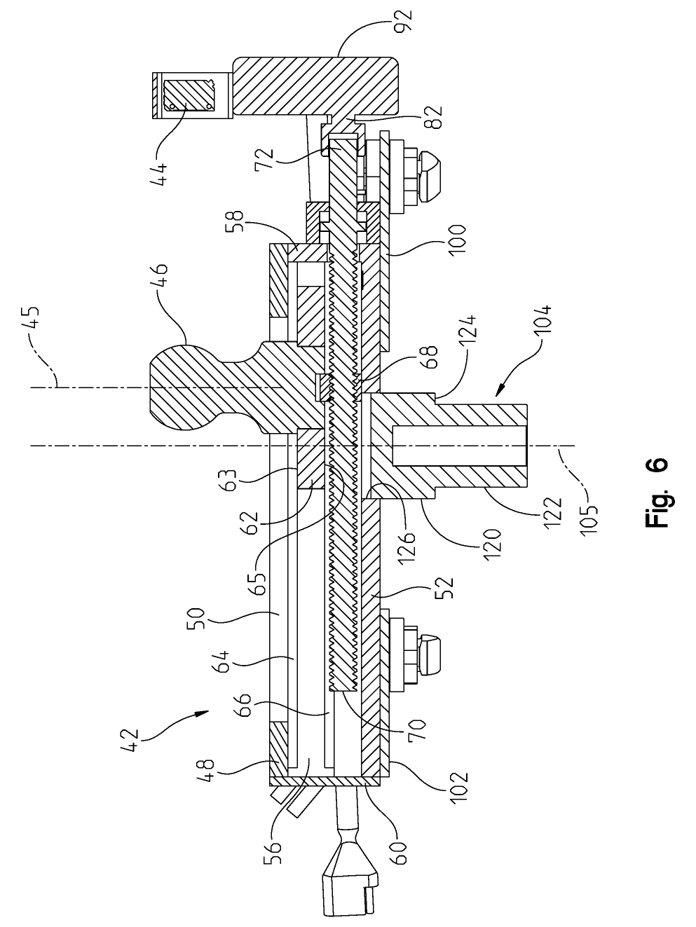

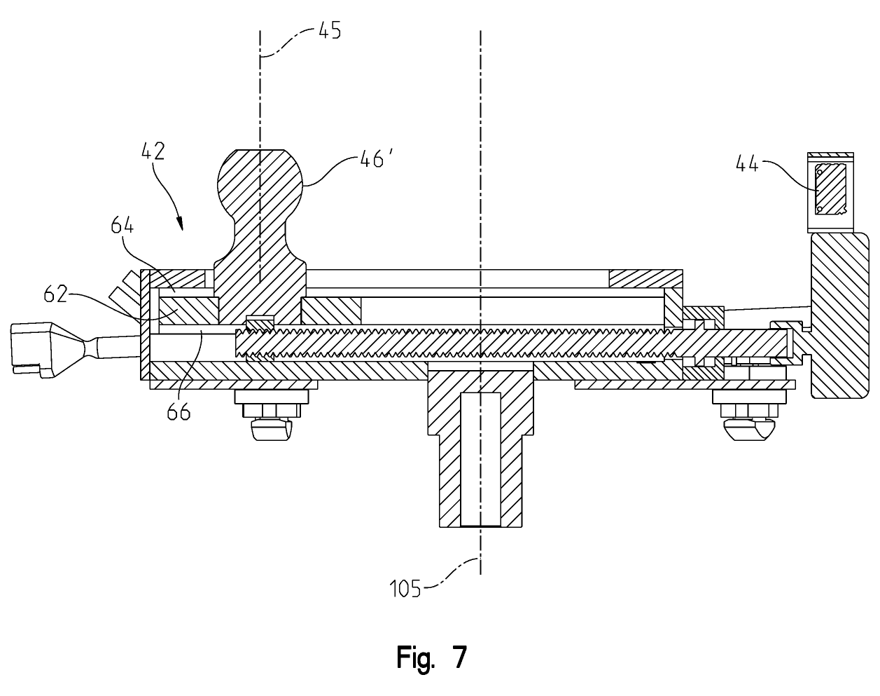

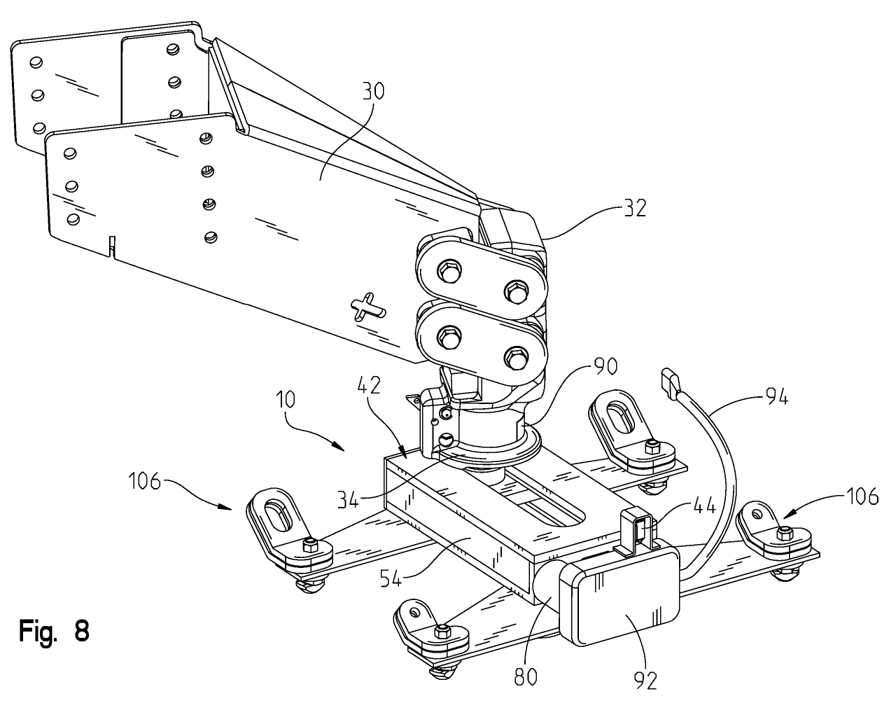

The trailer coupler 10 has a base frame 40 that has a linear actuator 42, a sensor 44, and components for affixing the trailer coupler 10 to the towing vehicle 12. The linear actuator 42 is an assembly of components that cooperate to support and move the gooseneck ball 46 longitudinally between a fore position (shown in FIG. 6) and an aft position (shown in FIG. 7). Throughout the travel of the linear actuator 42, the gooseneck ball 46 does not rotate and only moves in a longitudinal direction with respect to the towing vehicle 12. The linear actuator 42 is a structural component that carries the load applied to the gooseneck ball 46 and transfers it to the towing vehicle 12. The linear actuator 42 can move to any position between the fore and aft positions while carrying the load of the trailer. The gooseneck ball 46 has a gooseneck axis 45 that extends vertically as shown in FIG. 6. The linear actuator 42 has a top plate 48 with an elongate slot 50. The elongate slot 50 has a fore end 51 and an aft end 53 located opposite from the fore end 51. Parallel to the top plate 48 and spaced therefrom is a bottom plate 52. Along with the plates 48, 52, sides 54, 56 and end walls 58, 60 form the outer structure of the linear actuator 42 that form a partially enclosed volume. Located in the partially enclosed volume and sandwiched between the top and bottom plates 48, 52 is a sliding block 62. The sliding block 62 is a flat structural component, an upper surface 63 and lower surface 65. The gooseneck ball 46 is affixed to the sliding block 62 and extends through the elongate slot 50 to form a movable portion of the linear actuator. The sliding block 62 is supported by an upper bearing block 64 and a lower bearing block 66 that reduce friction when the sliding block 62 moves between the fore and aft positions. The bearing blocks 64, 66 can be a solid block of material with improved wear properties, a bearing assembly with moving parts, or equivalent. The length and width of the sliding block 62 transfers forces on the gooseneck ball 46 to the outer structure of the linear actuator 42. In other words, the linear actuator 42 transfers forces to the vehicle 12 that come from the gooseneck ball 46. A captured nut 68 is affixed or otherwise captured to the sliding block 62 so that movement of the captured nut 68 also moves the sliding block 62. As shown in section view FIG. 6, a screw shaft 70 is held within the linear actuator 42 and mated to the captured nut 68 so that when the screw shaft 70 rotates, the captured nut 68 creates fore or aft movement of the gooseneck ball 46. As shown, the screw shaft 70 is an Acme lead screw, but other screw types are contemplated. The screw shaft 70 protrudes through the end wall 58 where it is coupled to a motor 80. The motor 80 has an output shaft 82 that connects to a terminal end 72 of the screw shaft 70. The linear actuator 42 or motor 80 may include a position sensor (not shown) to communicate the position of the captured nut 68, gooseneck ball 46, or other movable components in the trailer coupler 10.

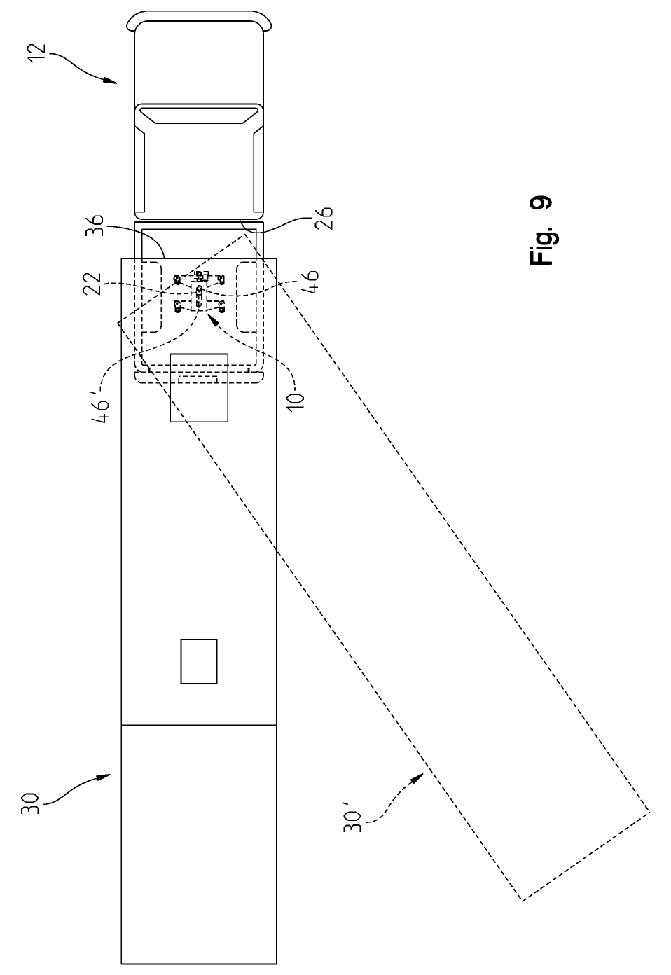

The sensor 44 is shown affixed to the motor 80, but other mounting options are contemplated. In the embodiment disclosed herein, the sensor 44 uses optical sensing technology to measure the presence or absence of a reflective flag 90. The flag 90 is affixed to the gooseneck coupler 32 that is affixed to the trailer 30. In the embodiment shown herein, the flag 90 has a width that translates to roughly 50 degrees of angular rotation of the trailer 30 in either direction before the flag 90 moves out of view of the sensor 44. When the towing vehicle 12 and trailer 30 are aligned (such as when traveling down a straight road), the sensor 44 detects the reflective flag 90. This is shown in FIG. 9 in solid lines. If the towing vehicle 12 and trailer 30 are at a large enough angle with respect to each other (such as when going around a corner or backing into a parking spot), the sensor 44 does not detect the reflective flag 90. In other words, if the sensor 44 doesn’t detect the flag 90, the angle is above a predetermined limit. This is shown in FIG. 9 with the trailer 30’ in broken lines. In the embodiment shown herein, the flag 90 is a band of material that is detected by the sensor 44 when located within the sensor’s sensing range. If the flag 90 is outside of the sensing range, the sensor 44 provides a signal that it does not detect the flag 90. It is also contemplated that instead of a presence/absence detection of the reflective flag 90, the sensor 44 measures the angle between the towing vehicle 12 and trailer 30. In this case, the predetermined limit may be determined by a settings in the controller. Other non-contacting or contacting sensing technologies are contemplated, such as magnetic, proximity, photographic, resistive, pressure, or angle. It is further contemplated that the sensor 44 provides a distance measurement for the fore/aft position of the actuator by measuring the distance of the flag 90 or the flag 90 is a fiducial marker.

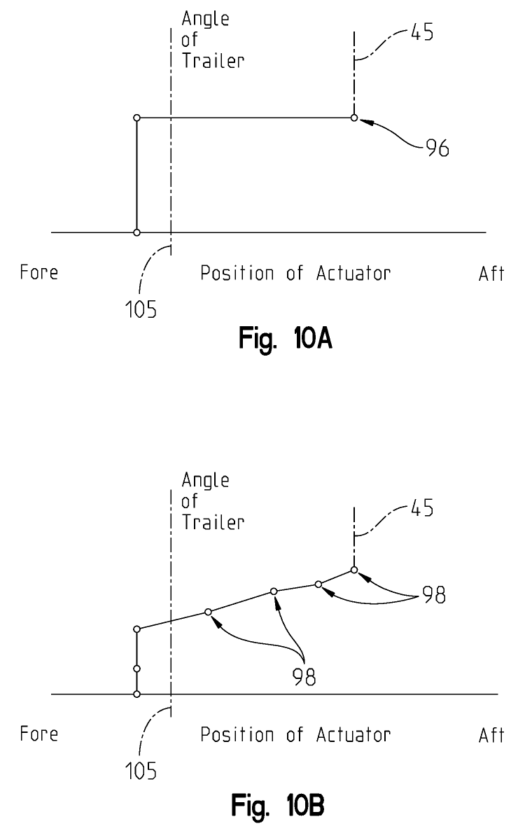

A controller 92 receives power through a power cord 94 and is in electrical communication with the sensor 44 and motor 80. If equipped, the position sensor for the linear actuator 42 is also in electrical communication with the controller 92. The controller 92 monitors the signal from the sensor 44 to determine the position of the trailer 30 relative to the towing vehicle 12. As shown in FIG. 9, the gooseneck ball 46 is moved forward when the trailer 30 and towing vehicle 12 are aligned. When the sensor 44 signals a sufficient angle between the towing vehicle 12 and trailer 30’, the controller 92 enables the motor 80 to move the gooseneck ball 46 towards the aft position, shown as 46’ in broken lines in FIG. 9. The relationship of the trailer angle and longitudinal position of the gooseneck ball is graphically represented in FIGS. 10A and 10B. FIG. 10A is a graph showing the position of the gooseneck ball 46 based on the angle of the trailer using a sensor 44 with a digital (on/off) output. When the angle is low and the sensor 44 can see the flag 90, the gooseneck ball 46 is in the fore position. In the embodiment shown herein, the fore position is forward of the gooseneck pocket 22 and stem axis 105, represented by the Y axis. The transition 96 between fore and aft in FIG. 10A occurs when the angle of the trailer causes the sensor 44 to no longer see the flag 90. When the sensor 44 detects that the towing vehicle 12 and trailer 30 are returning to alignment, the controller 92 enables the motor 80 to move the linear actuator 42 towards the fore position. For other embodiments using a sensor 44 that measures the angle of the trailer 30 (either directly or indirectly), it is possible for the user to program setpoints 98, slope, and positions for the linear actuator 42 for the predetermined limits, such as shown in FIG. 10B.

An optional handheld control (not shown) is in communication with the controller 92 and may be in the form of a wireless or wired remote control, mobile device application, or other method to move the linear actuator 42, read information and status of the sensor 44, read the position of the linear actuator 42, assist the user with troubleshooting, or add position presets for the fore/aft position of the gooseneck ball 46. The power cord 94 receives power from an existing vehicle wiring harness or trailer connection.

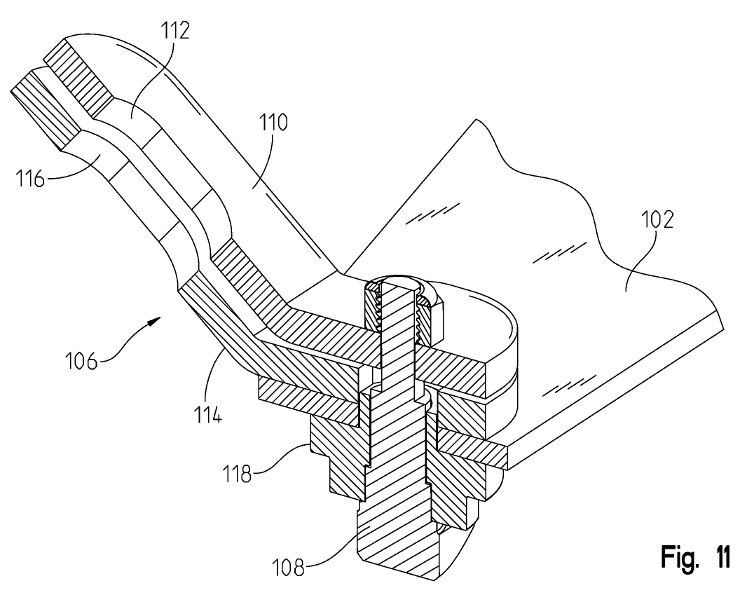

The base frame 40 includes a fore mounting portion 100, an aft mounting portion 102, and a stem 104. The fore and aft mounting portions 100, 102 and stem 104 are affixed to the linear actuator 42. The mounting portions 100, 102 have rotatable fasteners 106 to mate with the anchor points 24. Each fastener 106 has a rotatable shaft 108 that is fixed with respect to a locking handle 110, such that rotating the locking handle 110 also rotates the rotatable shaft 108. At the end of each rotatable shaft is a key feature that rotates with the shaft 108 and locks to the anchor points 24 when received by them and the locking handle 110 is then rotated to the locked position. A fixed handle 114 is adjacent the locking handle 110. When the locking handle 110 is rotated to a locked position, shown in FIG. 11, the locking handle 110 and fixed handle 114 are in alignment such that locking apertures 112, 116 in the handles are in alignment to receive a lock, pin, or other device to prevent the locking handle 110 from being rotated away from the locked position. The rotatable fasteners 106 also include an alignment bushing 118 that centers the rotatable shaft 108 and provides the proper alignment for engagement with locking features in the anchor points 24.

The stem 104 has a stem axis 105 and mates with the gooseneck pocket 22 and has a major diameter 120 and a minor diameter 122. As installed on the towing vehicle 12, the minor diameter 122 is located inside the gooseneck pocket 22 and the step 124 where the major diameter 120 begins and is supported by the gooseneck pocket 22. As shown, the stem 104 is affixed in an aperture 126 in the bottom plate 52 of the linear actuator 42. As the linear actuator 42 moves between the fore and aft positions, the gooseneck axis 45 crosses the stem axis 105. It is also contemplated that the linear actuator 42 is affixed to or integrated with the trailer 30 or gooseneck coupler 32. In the embodiment shown herein, the stem 104 is only located in the gooseneck pocket 22 and not affixed thereto. The coupler 10 is affixed to the vehicle using the rotatable fasteners 106.

As previously described, the gooseneck coupler 32 attaches or is affixed to the frame of the trailer 30. As shown in FIG. 3, the gooseneck coupler 32 mates to the gooseneck ball 46 to connect the trailer 30 to the towing vehicle 12. The gooseneck coupler 32 is moveable between a locked position and an unlocked position. In the locked position, the gooseneck ball 46 is trapped within a gooseneck ball cavity 38. In the unlocked position, the gooseneck ball 46 can enter or exit the gooseneck ball cavity 38 for mating and un-mating with the gooseneck ball 46.

To install the trailer coupler 10 on the towing vehicle 12, the user first rotates the rotatable fasteners 106 to the unlocked position and removes any dust covers from the gooseneck pocket 22 and anchor points 24 on the towing vehicle 12. The user then aligns the stem 104 to the gooseneck pocket 22 and lowers the coupler 10 to mate the rotatable fasteners 106 with the anchor points 24. The user then rotates the rotatable fasteners 106 to the locked position and adds any locks or pins as needed or required. The user then connects the power cord 94 to the vehicle 12. Once power is applied to the coupler 10, the user can then jog the actuator 42 to move the gooseneck ball 46 to the desired starting position. If the trailer 30 is not mated to the gooseneck ball 46 or if the flag 90 is not affixed to the gooseneck coupler 32, the controller 92 may move the gooseneck ball 46 to the aft position. Once the trailer 30 is coupled to the gooseneck ball 46 and the flag 90 is detected by the sensor 44, the controller moves the gooseneck ball 46 to the fore position. During normal towing (where the towing vehicle 12 and trailer 30 are aligned), the controller 92 maintains the gooseneck ball 46 in the fore position. The fore position is either determined by a preset that the user has set, or it is fully forward where the linear actuator 42 has reached a mechanical limit. If the towing vehicle 12 and trailer 30 are moved out of alignment (such as when backing into a parking space or navigating a tight turn), the flag 90 rotates out of view of the sensor 44 and the controller 92 moves the gooseneck ball 46 to the aft position. The aft position is either determined by a preset that the user has set or it is fully rearward where the actuator 42 has reached a mechanical limit, such as the gooseneck ball contacting the aft end 53 of the elongate slot 50.

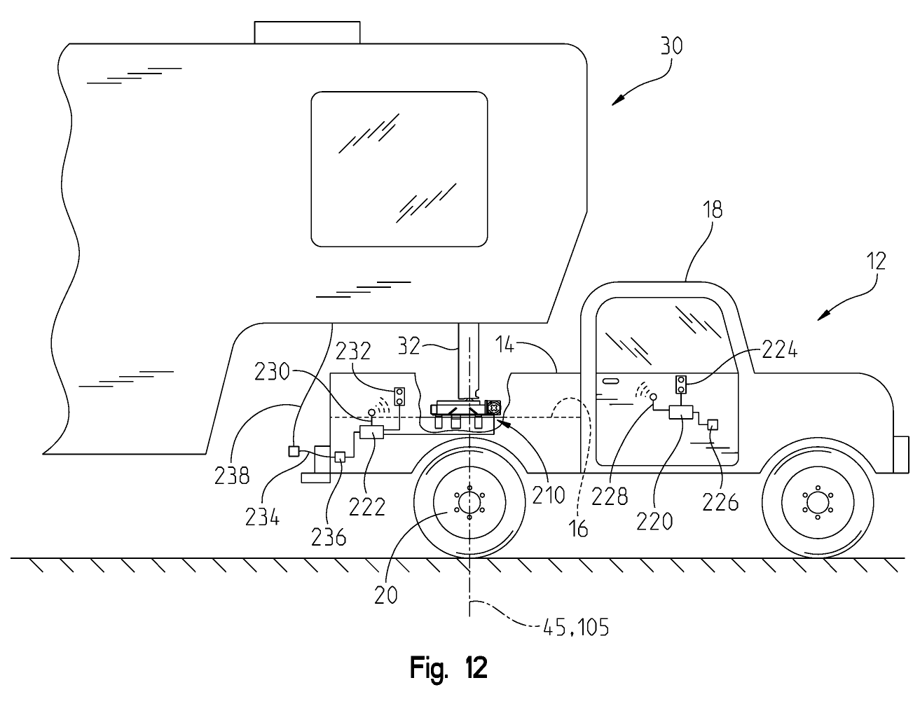

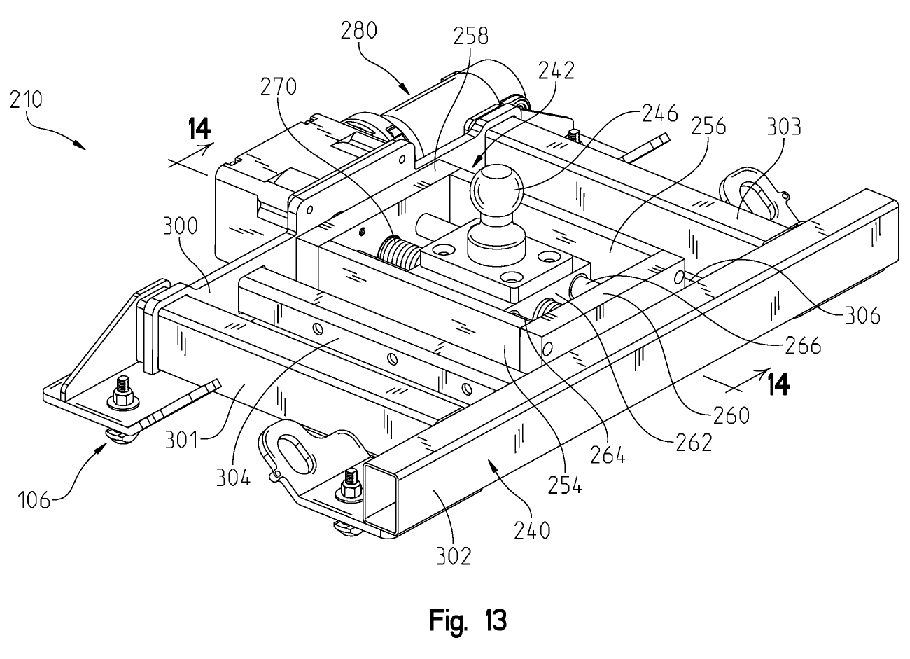

Another embodiment of the trailer coupler 210 is shown in FIGS. 12-15. The coupler 210 operates without the position sensor 44 described in use with coupler 10. The coupler 210 has a base frame 240 affixed to a linear actuator 242. The base frame 240 is an assembly of sheet metal and metal tube that is cut, formed, and secured together to form a rigid structure. The base frame 240 has a forward mounting plate 300 that is affixed to a rearward mounting tube 302 through longitudinal tubes 301, 303. Actuator mounting tubes 304, 306 also extend between the forward mounting plate 300 and rearward mounting tube 302. Attached at the corners of the base frame 240 are rotatable fasteners that mate with anchor points 24 on the towing vehicle 12. The trailer coupler 210 connects to the towing vehicle 12 using rotatable fasteners 106 and stem 104.

The linear actuator 242 is an assembly of components that cooperate to support and move a gooseneck ball 246 longitudinally between a fore position and an aft position. The actuator 242 has a bottom plate 252 with a stem, sides 254, 256, and end walls 258, 260. Guide rods 264, 266 are secured to the end walls 258, 260 that allow a sliding block 262 to move between a fore and aft position. A screw shaft 270 is mated to the sliding block 262 and is driven by a motor 280. A gooseneck ball 246 is affixed to the sliding block 262.

The motor 280 is controlled by a control system that includes a cab side controller 220 and a bed side controller 222. The cab side controller 220 and bed side controller 222 communicate through wireless communication, but a wired connection is contemplated. The cab side controller 220 has a manual control 224 and is connected to the vehicle’s communication bus through an on-board diagnostic (OBD) connector 226. The OBD connector provides power to the cab side controller 220, along with information about the vehicle. The available information includes the vehicle information, speed, throttle and braking inputs, and steering angle. Wireless communication between the cab side controller 220 and bed side controller 222 is accomplished with antennas 228, 230. The antennas 228, 230 are shown extending beyond the controllers 220, 222, but these are typically integrated into the enclosures to prevent damage. The bed side controller 222 is electrically connected to the motor 280, a manual control 232, antenna 230, and vehicle power. It is contemplated that the bed side controller 222 and motor 280 are combined into a single physical device. It is also contemplated that the motor 280 or actuator 242 contain position sensors to provide fore/aft position information to the controllers 220, 222. Vehicle power is supplied to the bed side controller 222 through a wiring harness 234 that is connected to a trailer connector 236. As shown, the trailer connector 236 is a standard 7-way connector at the rear of the vehicle that supplies the trailer 30 with braking power, along with turn and stop light signals through a trailer harness 238. The wiring harness 234 connects between the existing trailer harness 238 and trailer connector 236.

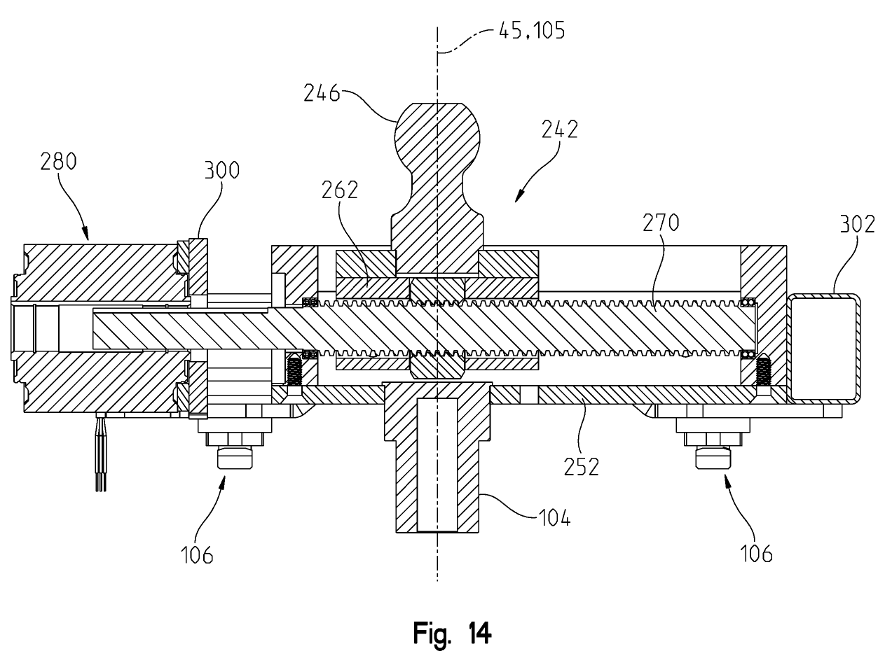

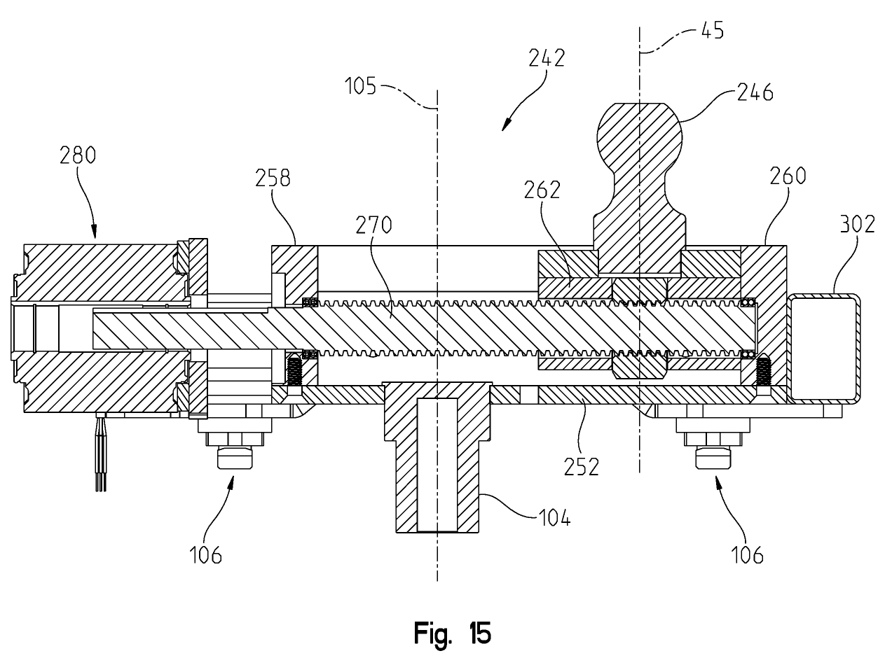

The motor 280 turns the screw shaft 270 to move the sliding block between the fore and aft positions. The fore position is shown in FIG. 14 with the stem axis 105 aligned with and coaxial to the gooseneck axis 45. With the coupler 210 installed on the towing vehicle 12, this locates the gooseneck axis 45 over the axle, as is shown in FIG. 12. While the fore position is shown with the axes 45, 105 exactly aligned, exact alignment is not necessary, and substantial alignment is adequate. Substantial alignment is defined as being close, such as 1-2 inches away. The aft position is shown in FIG. 15, showing the gooseneck axis 45 being spaced from and rearward of the stem axis 105. The vehicle 12 has a driving condition, which includes speed, turning, direction, braking, and acceleration. While driving the vehicle, the driving condition can be constantly changing, such as when in stop-and-go traffic, parking, or navigating a narrow road. At other times, the driving condition can be relatively constant, such as when driving on a desolate straight highway. The controller 220, 222 has access to information about the driving condition through the OBD connector 226. For the purposes of this disclosure, there are two driving conditions, each condition corresponds to a desired position of the gooseneck ball 246. One condition needs to ensure clearance between the cab 18 and trailer 30, and the other condition is optimized for weight distribution. In the embodiment shown herein, and by way of a non-limiting example, the driving condition corresponds to vehicle speed. Above a certain speed, the vehicle 12 would not be turning tightly enough to make the trailer 30 contact the cab 18, so the gooseneck ball 246 can be located in the fore position. Below that certain speed, the user could be backing, parking, or tightly turning, so it is safest to locate the gooseneck ball 246 in the aft position. It is contemplated that the vehicle condition (that determines whether the controller 220, 222 moves the gooseneck ball) could be steering angle, forward/reverse direction, braking, or acceleration, either separately or in combination with vehicle speed.

To install the coupler 210, the user secures it to the vehicle 12 and connects the bed side controller 222 using the wiring harness 234. The manual control 232 is secured in a convenient location for the user. The user connects up the cab side controller 220 by connecting it to the OBD connector 226. The manual control 224 is secured in a convenient location for the user, preferably within easy reaching distance from the driver’s seat. Once power is supplied to the controllers 220, 222, pairing may be required, either using a mobile device, application, using buttons on the controllers 220, 222 or manual controls 224, 232. The manual controls 224, 232 include buttons to manually move the linear actuator 242, provide status of the controllers 220, 222, position of the linear actuator 242, allow user programming, or indicate a fault condition.

Operation of the coupler 210 is as follows: the linear actuator 242 is moveable between a fore position (shown in FIG. 14) and an aft position (shown in FIG. 15). The fore position represents ideal weight distribution with the trailer tongue load directly (or nearly directly) over the vehicle’s rear axle. The aft position represents ideal positioning of the trailer 30 for turning, backing, or slow-speed navigating to prevent the trailer from contacting the cab. One indicator that distinguishes the difference between ideal towing for weight distribution and ideal positioning to prevent impact is the vehicle’s speed. Another indicator is steering angle. In the embodiment shown herein, vehicle speed is used when the vehicle 12 is stopped or below a predetermined speed, the linear actuator 242 (and gooseneck ball 246) is moved to the aft position. The aft position allows the user to navigate, reverse, park, etc. without the front surface 36 of the trailer contacting the rear surface 26 of the cab. When the vehicle 12 is above the predetermined speed (as communicated through the OBD connector 226), the cab side controller 220 communicates with the bed side controller 222 to move the linear actuator 242 to the fore position. The linear actuator 242 can also be moved manually with the manual controls 224, 232. It is contemplated that vehicle speed is determined by a GPS signal internal to the controller(s) 220, 222 instead of through the OBD connector 226. It is further contemplated that other vehicle conditions are used to move the linear actuator 242, such as steering angle, transmission position (gear/forward/reverse), and/or braking or accelerator position. If communication is lost between the controllers 220, 222 or a fault condition occurs, the controller can move the gooseneck ball 246 to the aft position to prevent property damage, along with the fault condition being communicated to the user through the manual controls 224, 232 or mobile application.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. An assembly for attaching a trailer to a towing vehicle, said towing vehicle having an axle, a gooseneck pocket, and at least two anchor points offset from said gooseneck pocket, said assembly comprising:
a base frame configured to be removably affixed to said towing vehicle, a stem fixed with respect to said base frame, said stem having a stem axis, said base frame having at least one fastener for being received by said anchor points, said fastener being rotatable between a locked position and an unlocked position;
a linear actuator having a motor and a stationary portion affixed to said base frame, said actuator having a gooseneck ball being moveable with respect to said base frame between a first position and a second position, said gooseneck ball having a gooseneck axis;
a controller in electrical communication with said towing vehicle and said linear actuator;
when said controller detects a first driving condition of said towing vehicle, said linear actuator moves said gooseneck ball to said first position, when said controller detects a second driving condition of said towing vehicle, said linear actuator moves said gooseneck ball to said second position.

2. The assembly of claim 1, wherein said first position is defined by said gooseneck axis being a first distance from said stem axis, said second position is defined by said gooseneck axis being a second distance from said stem axis.

3. The assembly of claim 2, wherein said first distance is closer to said stem axis than said second distance.

4. The assembly of claim 1, wherein said first driving condition is defined by said towing vehicle being over a predetermined speed, said second driving condition is defined by said towing vehicle being below said predetermined speed.

5. The assembly of claim 1, when said gooseneck pocket receives said stem and at least one of said anchor points receives a complementary said fastener, said base frame is affixed to said towing vehicle.

6. The assembly of claim 1, when said assembly is affixed to said towing vehicle, said first position is defined by said gooseneck ball being over said axle, said second position is defined by said gooseneck ball being rearward of said axle.

7. The assembly of claim 1, wherein said controller has a cab portion and a bed portion, said cab portion is in wireless communication with said bed portion.

8. The assembly of claim 7, wherein said cab portion is in communication with said towing vehicle through a diagnostic port on said towing vehicle.

9. The assembly of claim 1, wherein said linear actuator has a sliding block, a threaded shaft, and guide rods, said sliding block is mated with said threaded shaft and said guide rods so that rotation of said threaded shaft moves said sliding block along said guide rods, said gooseneck ball is affixed to said sliding block.

10. The assembly of claim 1, wherein said first position is defined by said gooseneck axis being substantially aligned with said stem axis, said second position is defined by said gooseneck axis being spaced from said stem axis.

11. A dynamically adjustable connection for coupling a trailer to a towing vehicle having an axle, a gooseneck pocket located over said axle, and at least two anchor points offset from said gooseneck pocket, said connection comprising:
a base frame having at least one fastener for being received by one of said anchor points on said towing vehicle, said fastener being rotatable between a locked position and an unlocked position;
a stem fixed with respect to said base frame and having a stem axis, said stem for being received by said gooseneck pocket on said towing vehicle;
a linear actuator affixed to said base frame, a gooseneck ball connected to said linear actuator and movable with respect to said base frame between an aft position and a fore position, said gooseneck ball having a gooseneck axis;
a motor coupled to said linear actuator and in electrical communication with a controller, said controller in communication with said towing vehicle;
when said towing vehicle speed is over a predetermined limit, said actuator moves said gooseneck ball towards said fore position, when said towing vehicle speed is below said predetermined limit, said actuator moves said gooseneck ball towards said aft position.

12. The connection of claim 11, wherein said linear actuator has a threaded shaft coupled to said motor and said gooseneck ball, rotation of said threaded shaft moves said gooseneck ball between said fore and aft positions.

13. The connection of claim 11, when said base frame is affixed to said towing vehicle, said fore position is defined by said gooseneck ball being over said axle, said aft position is defined by said gooseneck ball being rearward of said axle.

14. The connection of claim 11, said gooseneck axis is substantially coaxial with said stem axis at said fore position, said aft position is defined by said gooseneck axis being rearward of said stem axis.

15. The connection of claim 11, wherein said controller has a cab portion and a bed portion, said cab portion is in wireless communication with said bed portion.

16. The connection of claim 15, wherein said cab portion is in communication with said towing vehicle through a diagnostic port on said towing vehicle.

17. A method of towing a trailer comprising:
providing a towing vehicle having an axle and a mounting area located above said axle, providing a gooseneck receiver on said mounting area;
affixing a linear actuator to said mounting area, said linear actuator having a gooseneck ball extending vertically therefrom and longitudinally moveable between a fore position and an aft position, said fore position defined by said gooseneck ball located over said axle, said aft position defined by said gooseneck ball located rearward of said axle;
providing a stem having a stem axis fixed with respect to said linear actuator, locating said stem in said gooseneck receiver, said gooseneck ball having a gooseneck axis parallel to said stem axis, said gooseneck axis is substantially coaxial with said stem axis at said fore position, said aft position defined by said gooseneck axis being rearward of said stem axis;
providing a controller, said controller communicating with said towing vehicle and said linear actuator;
coupling said trailer to said gooseneck ball;
measuring a speed of said towing vehicle;
moving said gooseneck ball toward said aft position when said speed is below a predetermined speed; and
moving said gooseneck ball toward said fore position when said speed is above said predetermined speed.

18. The method of claim 17, connecting said controller to said vehicle at a diagnostic port, said controller receiving said speed of said towing vehicle through said diagnostic port.

19. The method of claim 17, wherein said controller has a cab portion and a bed portion, said cab portion wirelessly communicating with said bed portion.
